(19) United States
(12) Patent Application Publication
(10) Pub. No.: US 2011/0169284 A1
(43) Pub. Date: Jul. 14, 2011

(54) Combination Chopsticks and Chopstick Rest and Apparatus for Production of Same

(76) Inventor: Daniel S. Rosen, Westlake Village, CA (US)

(21) Appl. No.: 12/684,700

(22) Filed: Jan. 8, 2010

(51) Int. Cl. A47G 21/00; A47G 21/10; B23Q 15/00; B27M 3/00

(52) U.S. Cl. 294/1.1; 144/402; 144/3.1

(57) ABSTRACT

There is disclosed a combination chopsticks and chopstick rest which are manufactured as a single unit. Bending the end of the chopsticks unit at a pair of incised grooves separates the chopstick rest. The remaining portion of the chopsticks unit comprises a pair of coherent chopsticks separated by a transverse cut and leaving a short uncut portion at the thickest end of the article. The chopsticks are separated by pulling them apart. The chopsticks may then be rested upon the previously separated rest, which may be imprinted with advertising, logos or other text and graphics, thus keeping the tips of the chopsticks off the eating surface and free of dirt, debris and germs, as well as keeping the eating surface clean. A method of manufacture of the combination chopsticks and chopstick rest is presented.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to chopstick rests.

2. Description of the Related Art

Chopsticks are common and popular eating utensils, particularly with oriental food dishes. Chopsticks are often made from wood and are packaged in paper sleeves until used and, after use, are many times discarded.

Chopsticks have two ends, one for holding food and the opposite end for being gripped by the user. However, many less capable people grip their chopsticks at other points, even near the food-holding end. When using chopsticks to dine, the food-holding ends necessarily get covered with sauce and bits of food. In many restaurants, chopstick rests are provided upon which the chopstick tips may be placed in order to avoid soiling the tablecloth and to avoid picking up bacteria or dirt from the table surface. Such chopstick rests are often made from fine woods or porcelains and must be cleaned between uses. These characteristics make them economical to use in only the more expensive restaurants.

Disposable chopsticks are manufactured in coherent or interconnected pairs, said coherence typically only extending along a short portion of abutting surfaces. When the chopsticks are to be used the coherent portion is forced apart.

### DESCRIPTION OF THE DRAWINGS

FIG. 1 is a top view of a combination chopstick and rest.

FIG. 2 is an elevated plan view of a combination chopstick and rest with a plain rest.

FIG. 3 is an elevated plan view of a combination chopstick and rest with a single notch rest.

FIG. 4 is an elevated plan view of a combination chopstick and rest with a double-notched rest.

FIG. 5 is a diagram of how a rest may be separated from chopsticks.

FIG. 6 is a diagram of a chopstick rest in use.

FIG. 7 is a diagram of a mechanism to create a chopstick rest utilizing a vertical stamping apparatus.

FIG. 8 is a diagram of a mechanism to create a chopstick rest utilizing a continuous rolling stamping apparatus.

FIG. 9 is a top view of a combination chopstick and rest wherein the rest is an extended length of material narrower than the pair of chopsticks and contiguous solely to a single chopstick

FIG. 10 is a top view of a combination chopstick and rest wherein the rest is an extended length of material narrower than the pair of chopsticks and contiguous to their midpoint.

FIG. 11 is an elevated plan view of a combination chopstick and rest wherein the simple rest is an extended length of material narrower than the pair of chopsticks and contiguous solely to a single chopstick

FIG. 12 is an elevated plan view of a combination chopstick and rest wherein the rest is an extended length of material narrower than the pair of chopsticks and contiguous to their midpoint.

FIG. 13 is an elevated plan view of a combination chopstick and rest wherein the rest has a logo imprinted thereon.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

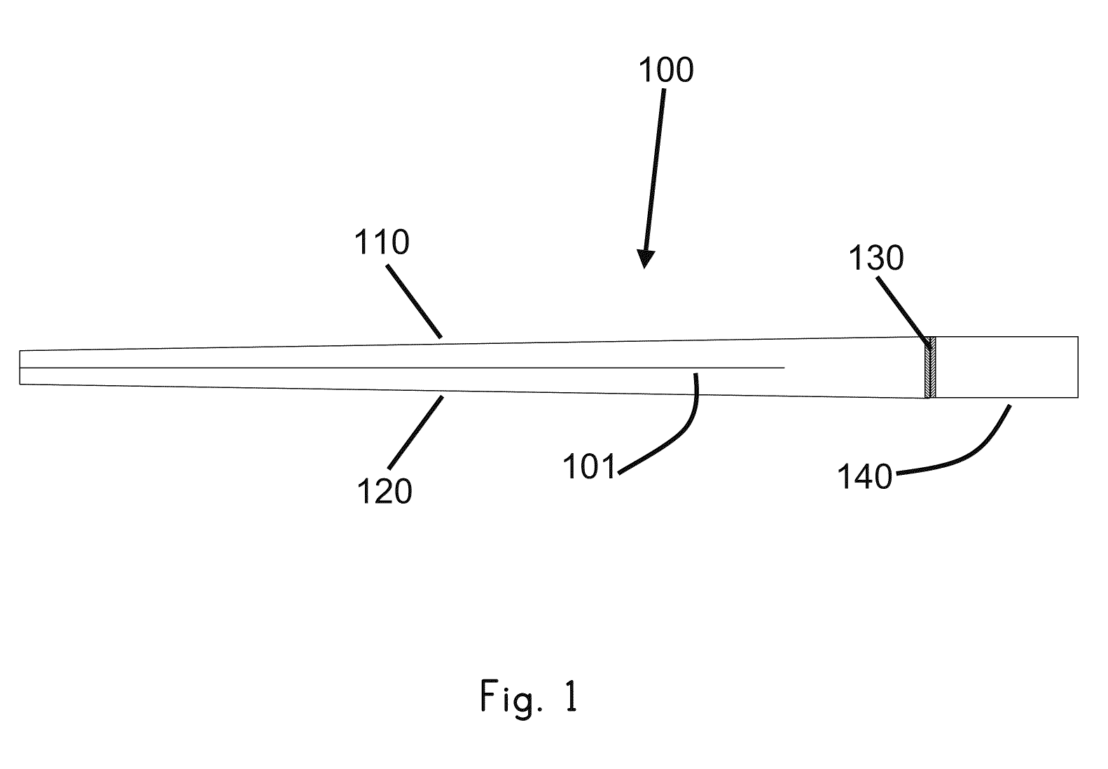

Referring now to FIG. 1, a disposable chopsticks unit 100 is composed of a pair of coherent sticks 110 and 120. The sticks 110, 120 may be formed from a single piece of wood with the longitudinal cut 101 extending a short way. Such chopsticks may be produced utilizing methods and apparatuses such as described in U.S. Pat. No. 4,840,208, U.S. Pat. No. 4,840,015, U.S. Pat. No. 5,373,880. Alternatively, the sticks may be made of another rigid material, such as plastic, composite, metal or combinations. An additional rectangular length 140 has been allowed on the single piece of wood or other material in order to function as the chopstick rest. A groove 130 has been made perpendicular to the longitudinal cut 101 and placed so that the desired length of the rest 140 may be separated from the chopsticks 110 and 120. A corresponding, identical groove has been made on the opposite side of the single piece of wood or other material from the groove 130 shown but is not visible in this view. Alternatively, the grooves 130 may be replaced by scoring or another method of providing a weakening of the chopsticks unit 100 material so that the additional rectangular length 140 may be readily detached from the chopsticks 110 and 120.

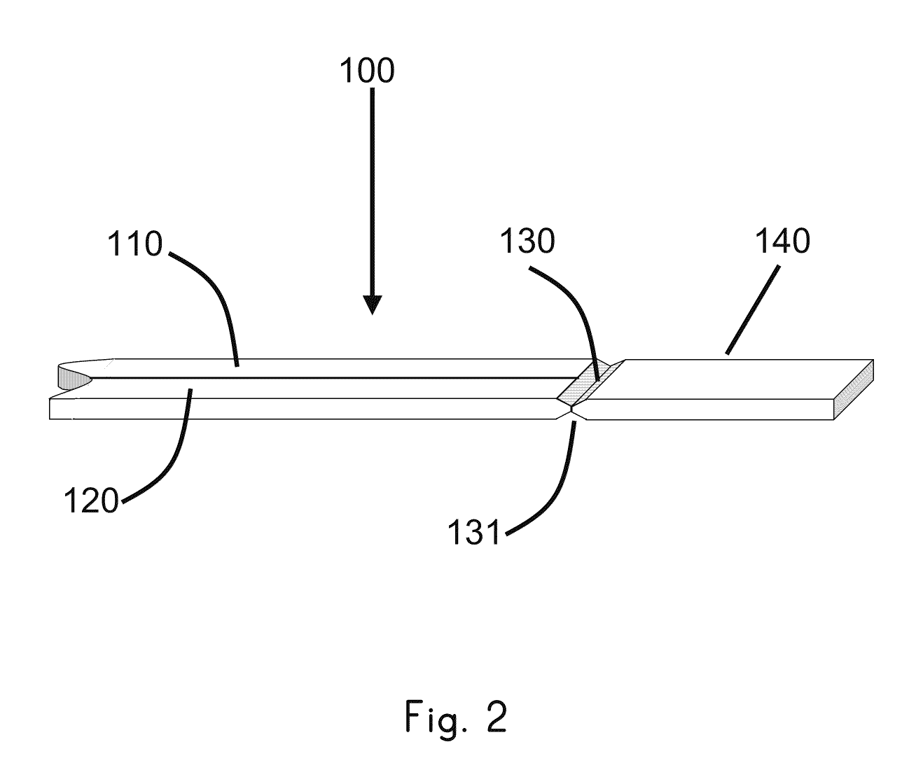

Referring now to FIG. 2, an elevated plan view of disposable chopsticks unit 100 is shown. This view reveals the two corresponding grooves 130, 131 which provide a means for separating the chopstick rest 140 from the chopsticks 110 and 120. The depth of the grooves 130, 131 should be such as to leave an amount of material sufficient to ensure that the chopstick rest 140 remains attached to the chopsticks 110 and 120 during processing, packaging, shipment and storage, but is thin enough that a person can break off the chopstick rest 140 cleanly and easily. The amount of strength needed may be based on average person, a weak adult, a child, a senior citizen or some other reference. The chopstick rest 140 shown comprises a smooth, flat rectangular piece of wood or other material. Both large rectangular faces of this material may be used for printing of advertisements, logos or other desired text or graphics.

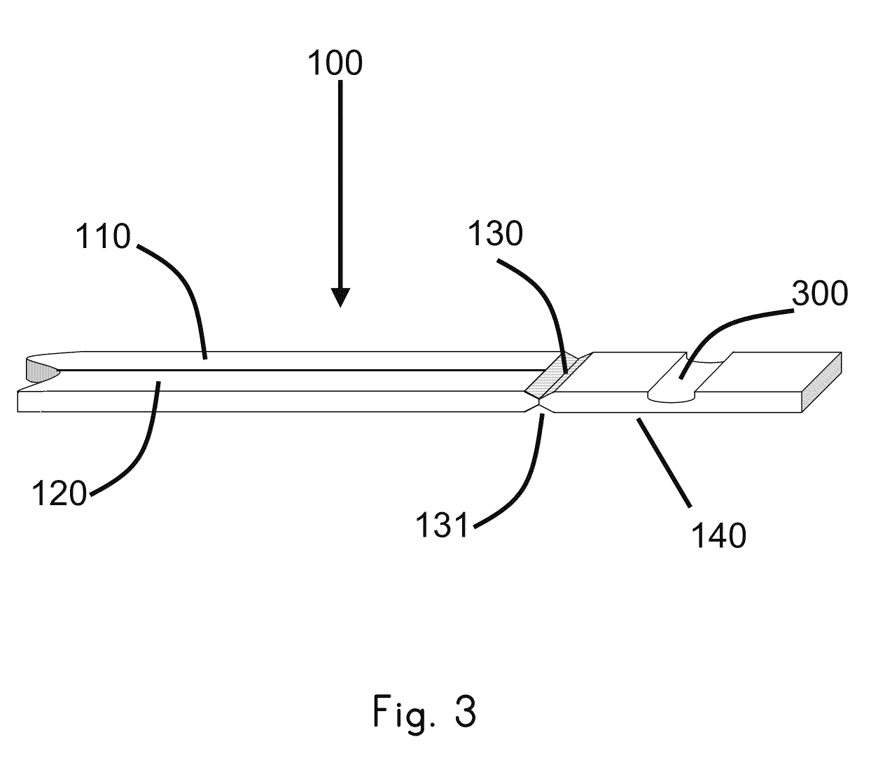

Referring now to FIG. 3, an elevated plan view of disposable chopsticks unit 100 is shown. The chopstick rest 140 shown has a small groove or indentation 300 stamped or cut into it. This groove or indentation 300 may be made large enough to serve as a catch area for the tips of the chopsticks 110 and 120 when they are laid upon the rest.

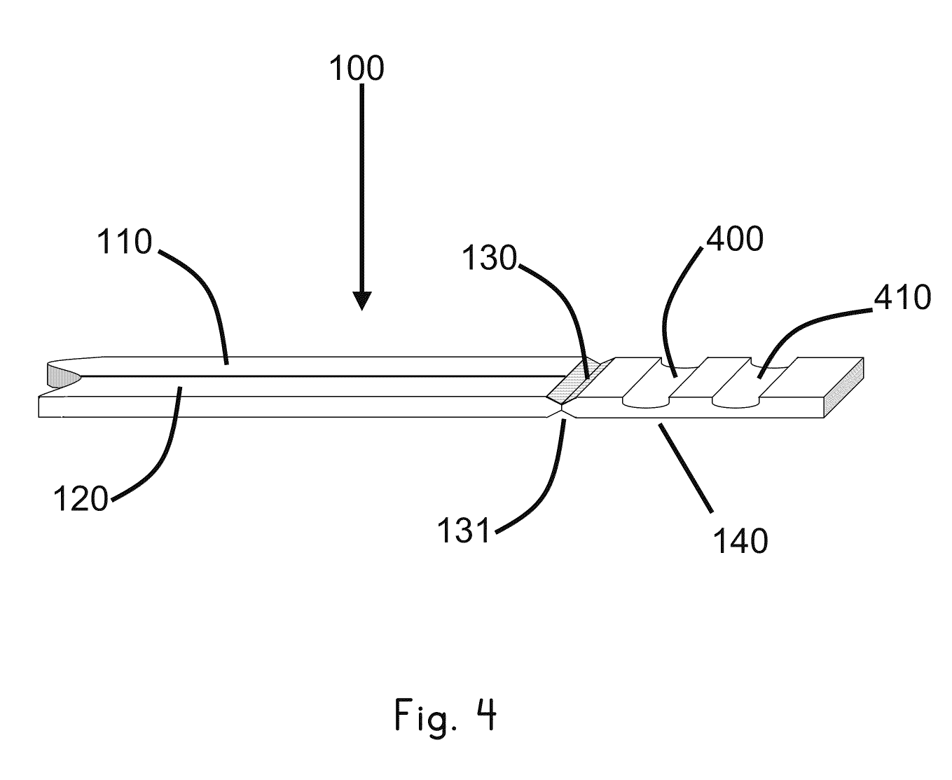

Referring now to FIG. 4, an elevated plan view of disposable chopsticks unit 100 is shown. The chopstick rest 140 shown has two small grooves or indentations 400 and 410 stamped or cut into it. These grooves or indentations are made large enough to serve as catch areas for the tips of the chopsticks 110 and 120 when they are laid upon the rest.

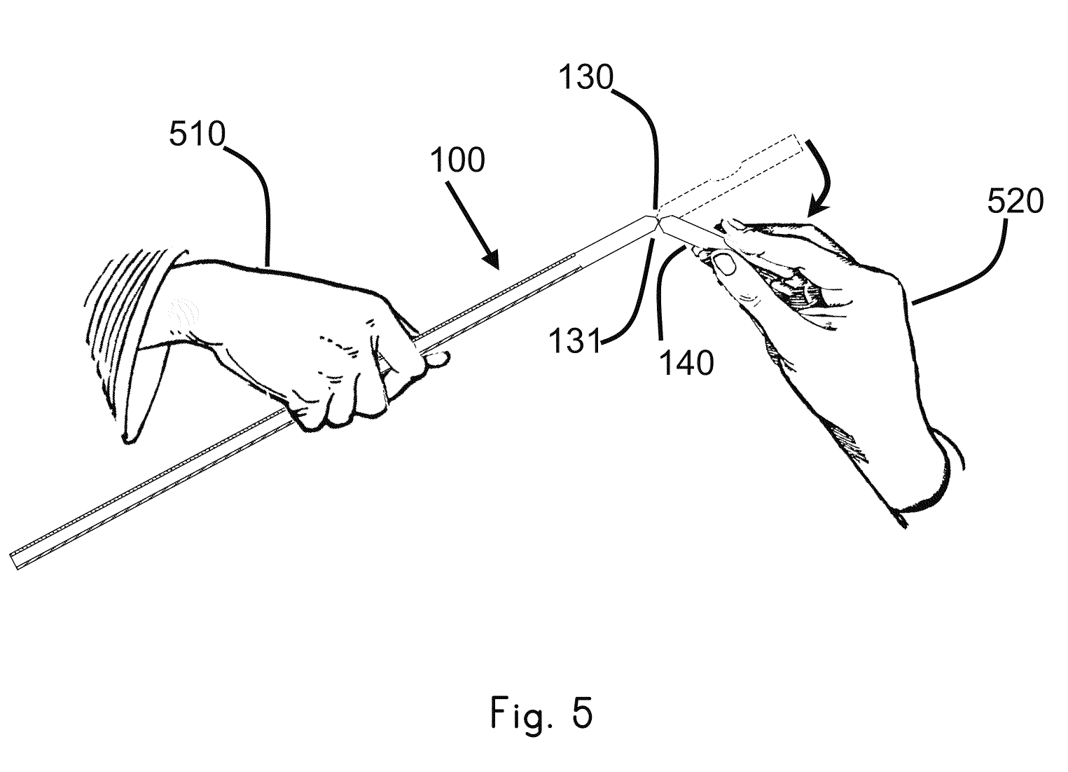

FIG. 5 illustrates a method of separating the chopstick rest 140 from the chopsticks 110 and 120. Holding the disposable chopsticks unit 100 in one hand 510, the user grasps the chopstick rest 140 in the opposite hand 520. By applying a firm downward motion on the chopstick rest 140, the rest breaks free of the chopsticks unit 100 along the grooves 130, 131. The motion may alternatively be upward, or in a direction compatible with the grooves 130, 131.

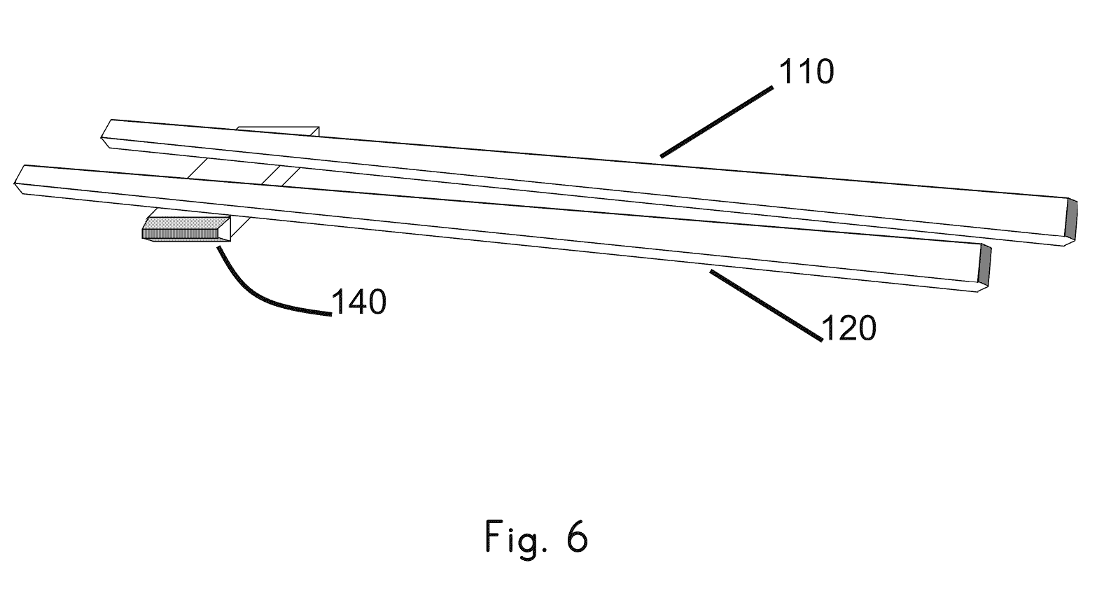

FIG. 6 illustrates the manner of usage of the chopstick rest 140. As is shown, the chopsticks 110 and 120 are laid upon the chopstick rest 140 in such a manner as to keep the tips of the chopsticks 110 and 120 elevated above the table surface. In the case of the chopstick rest 140 having a single groove 300 (FIG. 3) or two grooves 400 and 410 (FIG. 4), the tips of the chopsticks 110 and 120 may be laid within these grooves if desired.

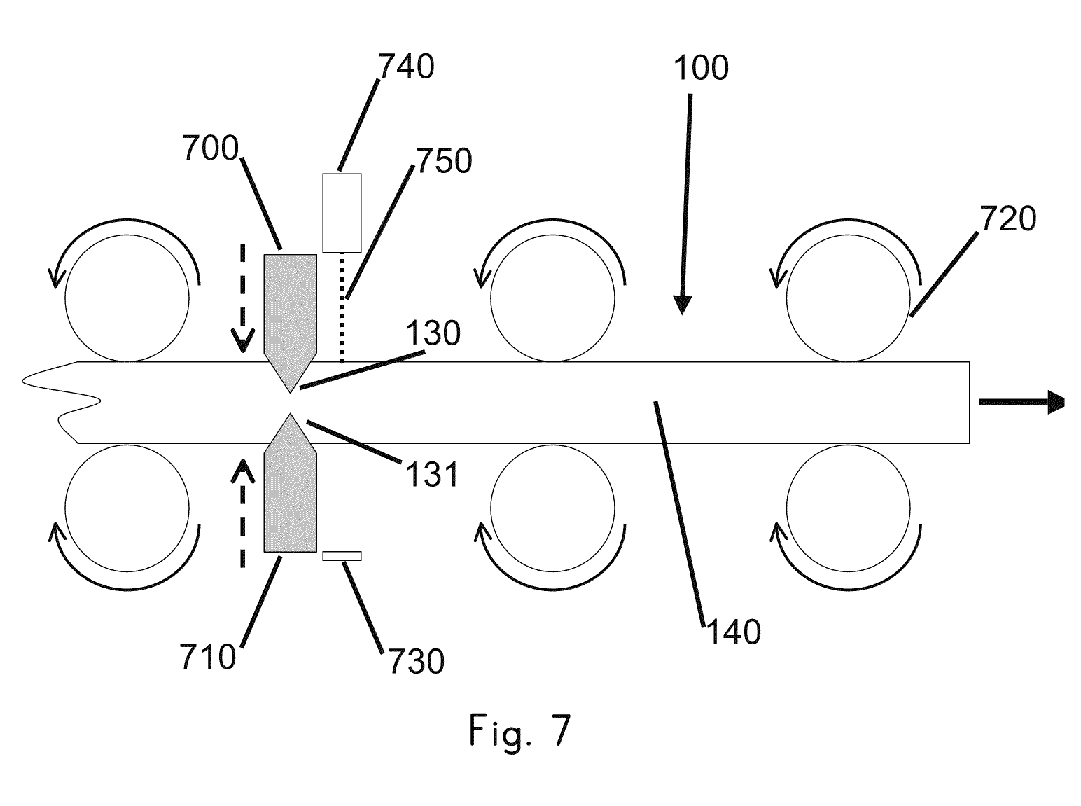

Referring now to FIG. 7, an apparatus is shown for the impression of the grooves 130, 131 into the chopsticks unit 100. The chopsticks units 100 may be continuously fed utilising an apparatus such as described in U.S. Pat. No. 5,373,880. A set of friction rollers 720 laid out in a linear set of counter-rotating pairs propels the chopstick unit 100 through the apparatus. Alternatively, the friction rollers 720 may be replaced by another means of propelling the chopsticks unit 100 through the apparatus, such as an intermittent conveyer belt or grapplers. At a given point in the apparatus, a laser diode 740 is located adjacent to a pair of stamping tools, 700 and 710, which are situated directly opposite of each other above and below the travel path of the chopstick unit 100. Opposite the laser diode 740 is a photosensor 730, which is sensitive to the wavelength of the laser diode 740. The photosensor 730 activates a timing circuit upon detecting light from the laser diode 740. Once the photosensor 730 no longer detects light from the laser diode 740, because the chopsticks unit 100 has now obstructed the laser beam 750, the timing circuit counts a sufficient amount of time for enough of the chopsticks unit 100 to have passed the laser beam to create a chopstick rest 140 of the desired length. The timing circuit controls single shot actuators for the stamping tools 700 and 710. When this circuit is closed, the single shot actuators activate a hydraulic system that drives the stamping tools with sufficient force to impress the grooves 130 into the chopsticks unit 100 to the desired depth and shape. The single shot actuators, immediately after the groove has been impressed, release the hydraulic system so that the stamping tools return to normal position. When the whole length of the chopsticks unit 100 has passed by the laser beam 750, the beam is no longer obstructed and will again be detected by the photosensor 730 whereupon the timing circuit is reactivated and the process proceeds again as described above.

Instead of the stamping tools 700 and 710 high speed milling bits or other cutting or sawing devices could be used.

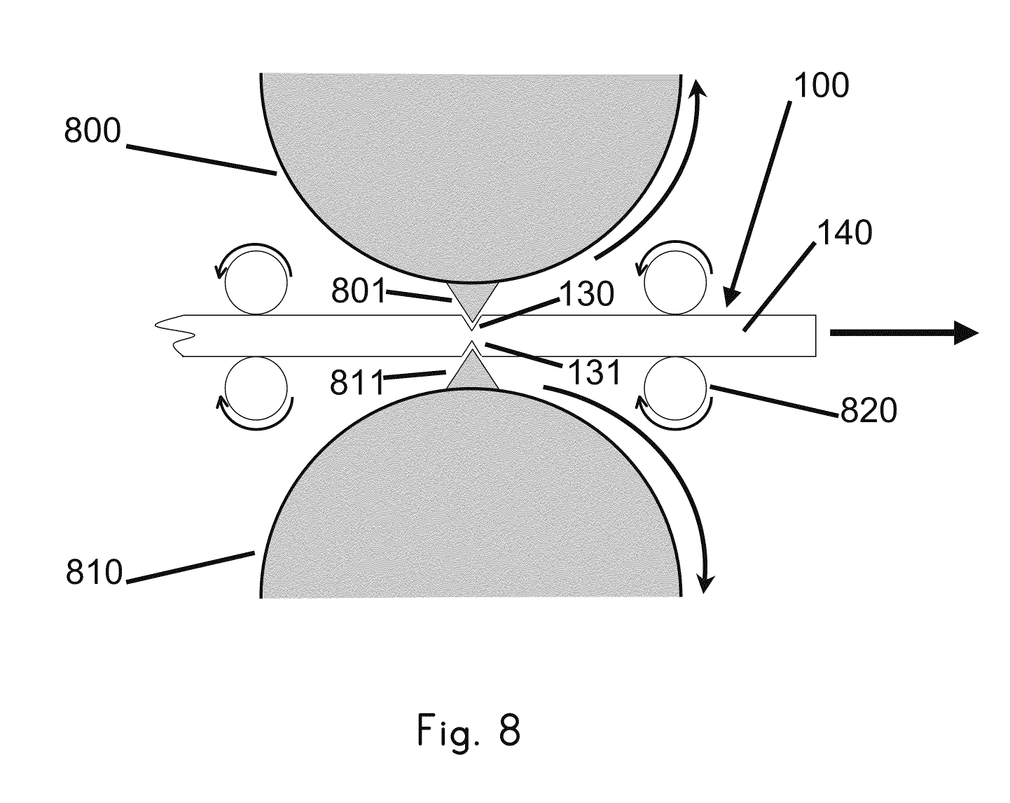

Referring now to FIG. 8, an apparatus is shown for the impression of the grooves 130, 131 into the chopsticks unit 100. A set of friction rollers 820 laid out in a linear set of counter-rotating pairs, propels the chopstick unit 100 through the apparatus. Alternatively, the friction rollers 820 may be replaced by another means of propelling the chopsticks unit through the apparatus, such as an intermittent conveyer belt or grapplers. As the chopstick unit 100 moves linearly through the apparatus, it passes between a set of rollers 800 and 810 each of which are fitted with a properly shaped stamp 801 and 811. The rollers 800 and 810 are of such a diameter that as they revolve the stamps 801 and 811 come into contact with the chopstick unit 100 so that the stamps 801 and 811 impress the grooves 130, 131 at a point which creates the chopstick rest 140 of the desired length. Mathematically, the rollers 800 and 810 should be of a diameter D such that if the distance from a set of grooves 130, 131 on a given chopstick unit 100 to the set of grooves 130, 131 on the next chopstick unit 100 moving through the apparatus is L, then D=L/π. The stamps 801 and 811 are of sufficient sharpness, and the pressure of the rollers 800 and 810 is of sufficient strength to impress the grooves 130, 131 into the chopsticks unit 100 to the desired depth and shape.

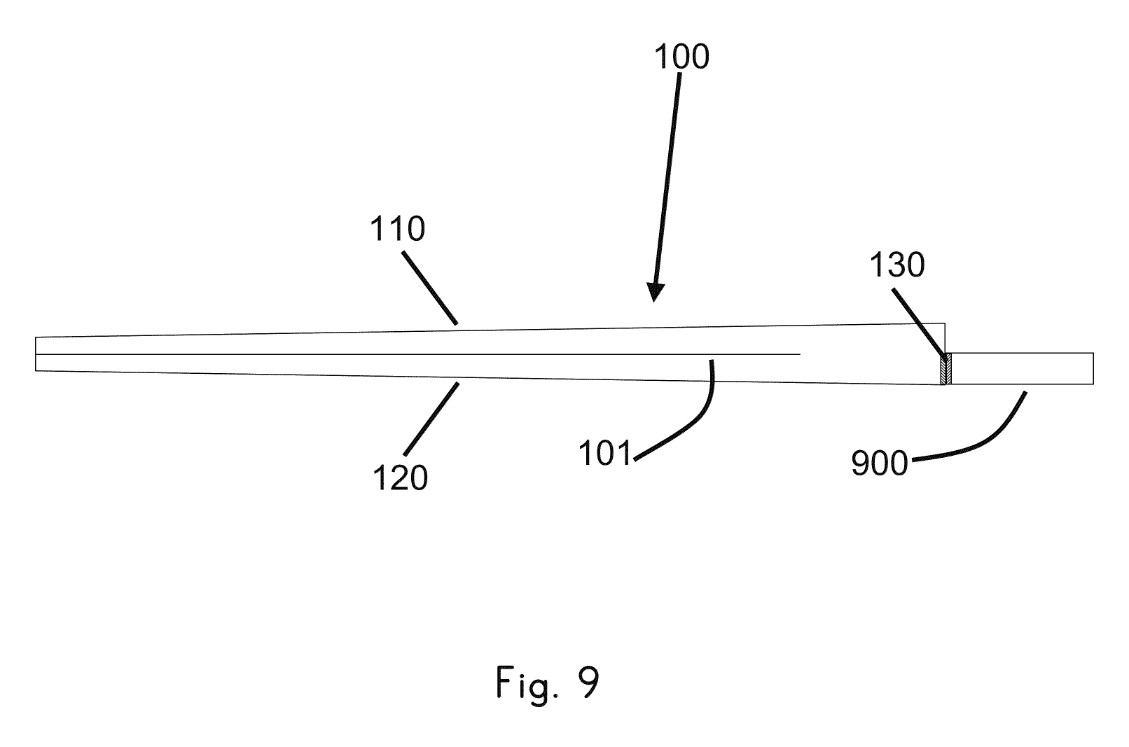

FIG. 9 shows an alternative configuration wherein the chopstick rest 900 is formed by material which is narrower than the coherent chopsticks 110 and 120 and the material is contiguous with one of the chopsticks 120.

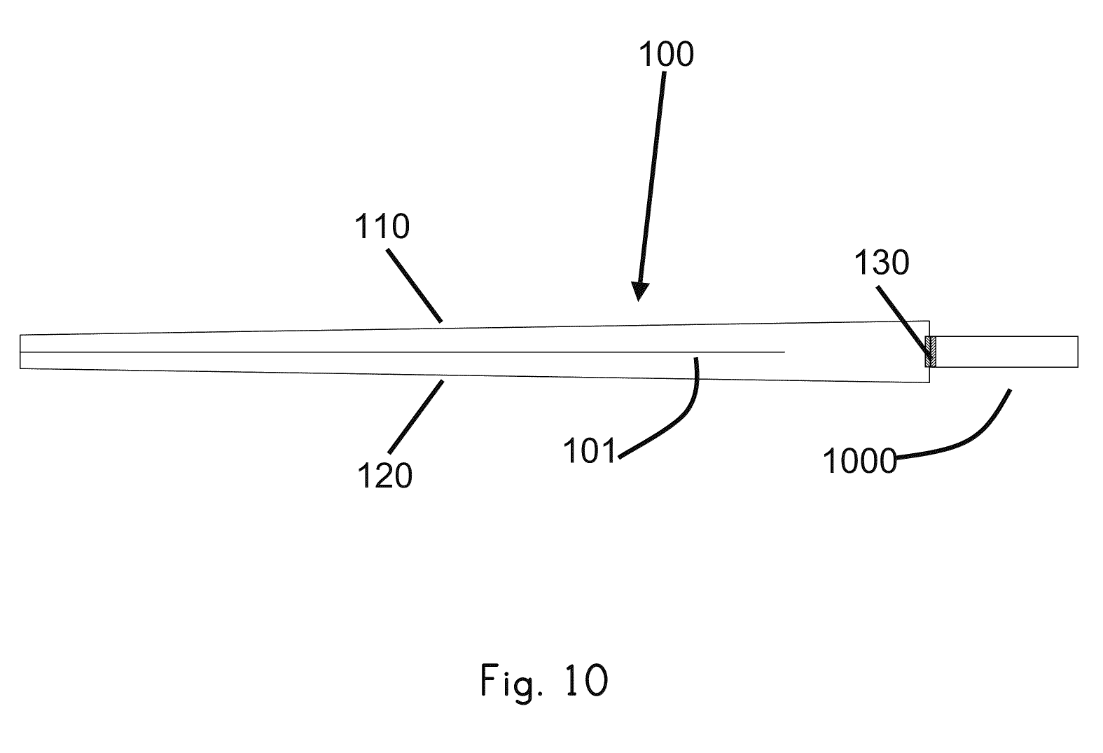

FIG. 10 shows an alternative configuration wherein the chopstick rest 1000 is formed by material which is narrower than the coherent chopsticks 110 and 120 and the material is contiguous with the midpoint of the chopsticks.

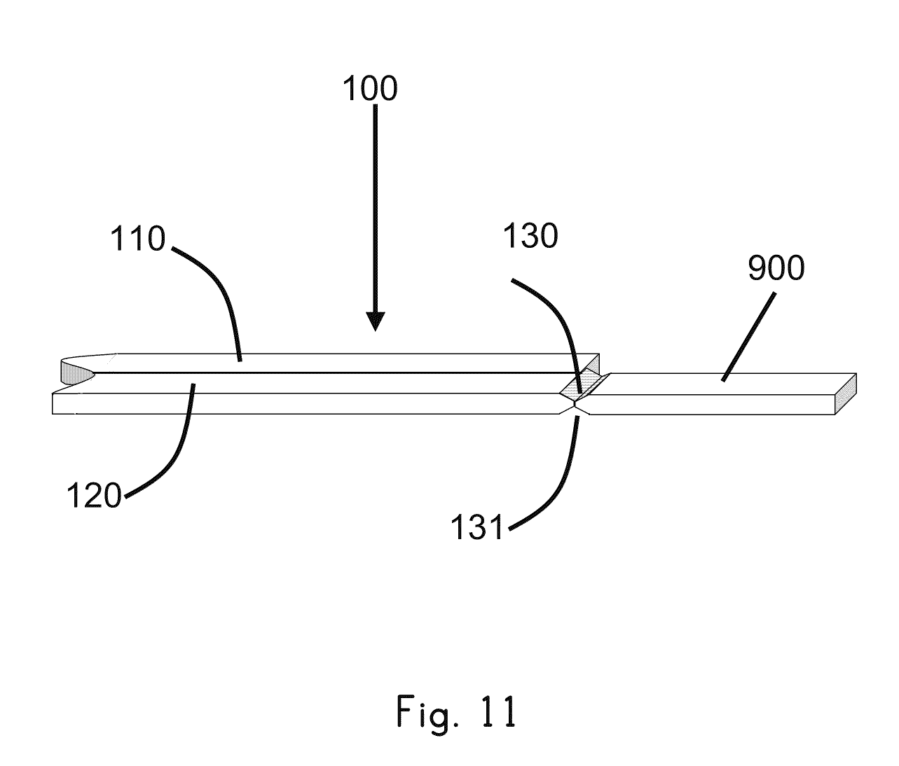

FIG. 11 shows an elevated plan view of the alternative configuration of FIG. 9. This view reveals the two corresponding grooves 130, 131 which provide a means for separating the chopstick rest 900 from the chopstick 120.

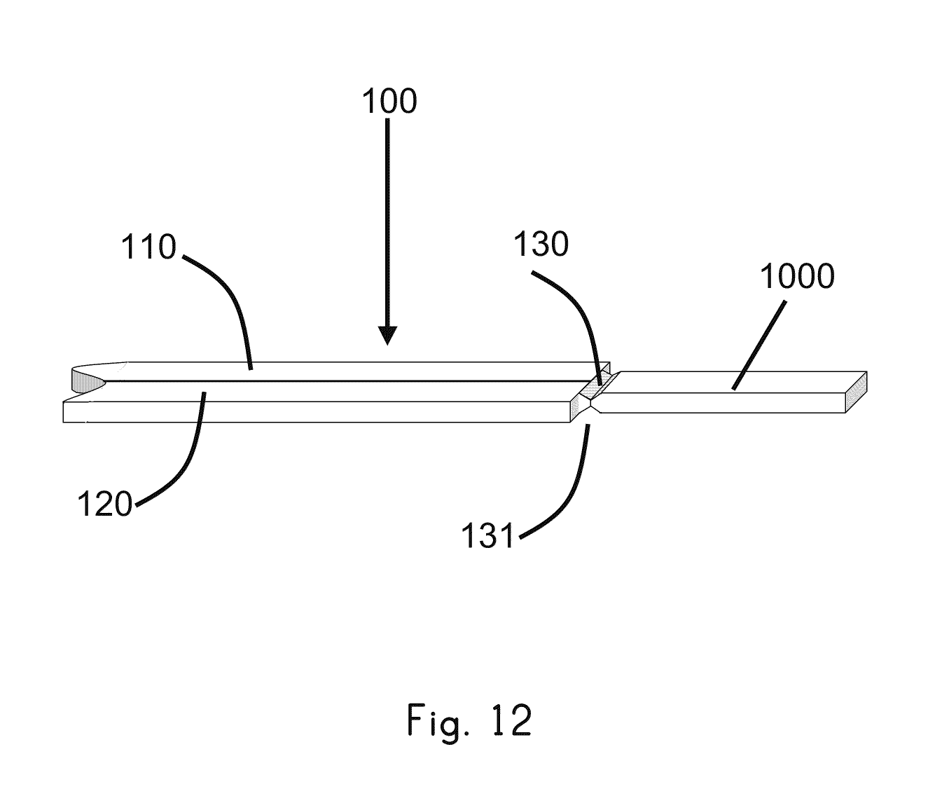

FIG. 12 shows an elevated plan view of the alternative configuration of FIG. 10, This view reveals the two corresponding grooves 130, 131 which provide a means for separating the chopstick rest 1000 from the chopsticks 110 and 120.

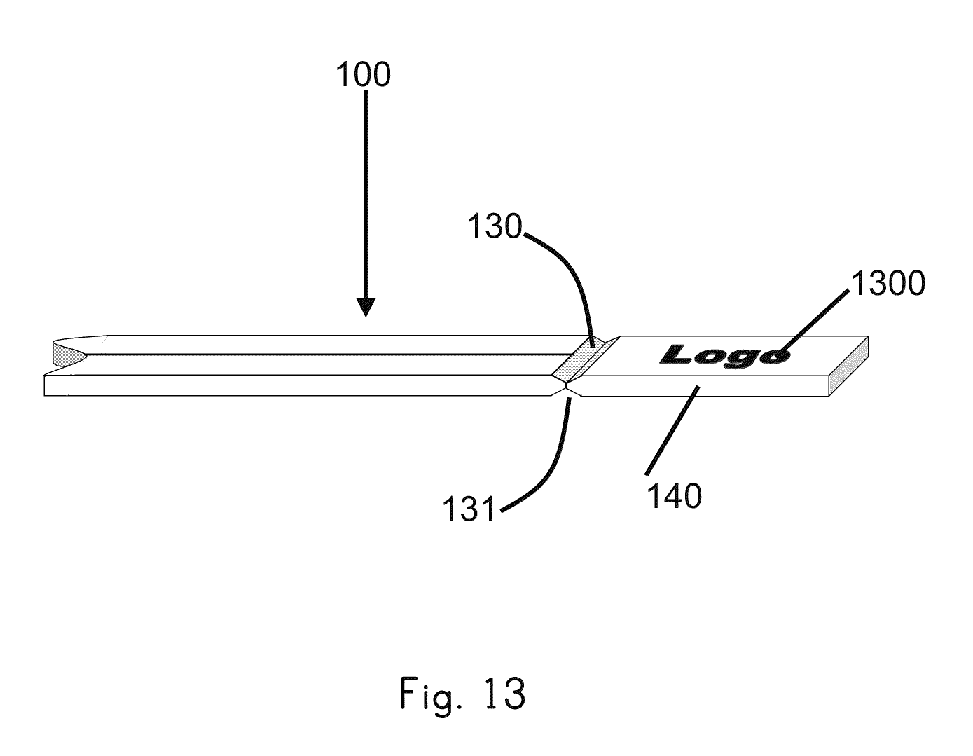

FIG. 13 shows an elevated plan view of disposable chopsticks unit 100 with a logo 1300 printed on one face of the chopstick rest 140. One of any of the faces of the chopstick rest 140 may have at least one of a logo, text and graphics printed thereon. This would allow for restaurants or other business to realize a form of advertising from the chopstick rest 140.

The grooves, indentations or scoring 130, 131 could be stamped, cut or incised into the chopsticks unit 100 as an additional production process following the creation of the finished chopsticks unit 100 as per U.S. Pat. No. 5,373,880 or similar production processes.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A chopstick unit comprising:
a pair of coherent detachably attached chopsticks
a chopstick rest comprising a separable, extended length of material contiguous with at least one of the coherent chopsticks and having first and second surfaces, the first surface being substantially flat and adapted to lie on a flat surface such as a table, and the second surface having an area and underlying composition sufficient to support both chopsticks.

2. The chopstick unit of claim 1, wherein at least one groove, scoring, notch or other modification is located between the coherent chopsticks and the chopstick rest and is of sufficient depth and shape that the separable, extended length of material may be detached easily and cleanly from the chopsticks

3. The chopstick unit of claim 1, wherein at least one of the surfaces of the chopstick rest is flat.

4. The chopstick unit of claim 1, wherein one surface of the chopstick rest has one smooth, curved groove therein and its opposite surface is flat.

5. The chopstick unit of claim 1, wherein one surface of the chopstick rest has two smooth, curved grooves therein and its opposite surface is flat.

6. The chopstick unit of claim 1, wherein one or both of the first and second surfaces of the chopstick rest has at least one of a logo, text and graphics printed thereon.

7. An apparatus for the production of a chopstick unit comprising:
at least one stamping tool for creating a groove, channel or score between a pair of coherent detachably attached chopsticks and a chopstick rest comprising a separable, extended length of material contiguous with at least one of the coherent chopsticks
a positioning device including at least one of a belt, a push-arm [etc] for placing the chopsticks unit at a first position between the stamping tools
a photodetector for detecting a chopstick unit in the first position comprising
at least one actuator coupled to the photodetector to cause a momentary movement of the stamping tool onto the detected chopsticks unit.

8. The apparatus of claim 7, wherein the positioning device is for moving the chopstick units into the first position and out of the first position.

9. The apparatus of claim 7, wherein the stamping tools have a sufficient sharpness and shape to create the groove, channel or score.

10. The apparatus of claim 7, wherein the photodetector comprises:
a laser diode having a laser output
a photosensor for sensing the laser output.
an interruptible circuit controlled by the photosensor comprising
a connection to a power source
a timing circuit powered by the power source
a switch opened and closed by the photosensor

11. The apparatus of claim 10, wherein the photodetector comprises optics for directing the laser output from the laser diode at the first position.

12. The apparatus of claim 10, wherein the photodetector comprises optics for directing the laser output from the first position to the photo sensor.

13. The apparatus of claim 10, wherein the interruptible circuit switch is opened by the photodetector sensor sensing radiation from the coherent radiation source

14. The apparatus of claim 10, wherein the interruptible circuit switch is closed by the failure of the photodetector sensor to sense radiation from the coherent radiation source.

15. The apparatus of claim 10, wherein the timing circuit starts a timing sequence when the photodetector senses that a chopstick unit is at the first location.

16. The apparatus of claim 10, wherein the timing circuit allows for the sufficient movement of a chopsticks unit to form a chopstick rest of the desired length.

17. An apparatus for the production of a chopstick unit comprising:
a pair of vertically opposed rollers
a chopsticks positioning mechanism for placing the chopsticks unit between the rollers
a pair of stamping tools contiguous with the surface of the rollers for creating grooves, channels or scoring between the chopsticks and the chopstick rest.

18. The apparatus of claim 17, wherein the chopstick unit comprises:
a pair of coherent detachably attached chopsticks
a chopstick rest comprising a separable, extended length of material contiguous with at least one of the coherent chopsticks and having first and second surfaces, the first surface being substantially flat and adapted to lie on a flat surface such as a table, and the second surface having an area and underlying composition sufficient to support both chopsticks.

19. The apparatus of claim 17, wherein the chopsticks positioning mechanism transports the chopsticks units longitudinally.

20. The apparatus of claim 17, wherein each of the vertically opposed rollers has one of the pair of stamping tools attached to its surface.

21. The apparatus of claim 17, wherein the stamping tools are of a proper sharpness and shape to create grooves.

22. The apparatus of claim 17, wherein each of the vertically opposed rollers is of a sufficient circumference that as they rotate at a given speed, the stamping tools in each roller are brought into contact with the chopsticks unit at a point to form grooves such that a chopstick rest of the desired length is created.
